(19) United States
(12) Patent Application Publication
(10) Pub. No.: US 2026/0100396 A1
(43) Pub. Date: Apr. 9, 2026

(54) METHOD FOR MANUFACTURING BATTERY

(71) Applicant: TOYOTA JIDOSHA KABUSHIKI KAISHA, Toyota-shi (JP)

(72) Inventors: Masato ONO, Nagoya-shi (JP); Tadashi TERANISHI, Toyota-shi (JP); Yusuke OISHI, Toyota-shi (JP)

(73) Assignee: TOYOTA JIDOSHA KABUSHIKI KAISHA, Toyota-shi (JP)

(21) Appl. No.: 19/226,644

(22) Filed: Jun. 3, 2025

(30) Foreign Application Priority Data
Oct. 4, 2024 (JP) 2024-175070

(51) Int. Cl. H01M 10/04; H01M 4/02; H01M 4/04

(52) U.S. Cl. CPC H01M 10/0404; H01M 4/0471; H01M 10/0468; H01M 2004/029

(57) ABSTRACT

A method for manufacturing a battery includes conveying a heated bipolar electrode stack in the form of an elongated sheet by a conveyor roller. In the method of the present disclosure, a first electrode active material layer includes a plurality of island portions extending in a conveying direction, and at least one gap extending in the conveying direction is present between the island portions. A temperature drop of the bipolar electrode stack as the bipolar electrode stack passes over the conveyor roller is 30° C. or more. The conveyor roller includes a recess positioned to overlap with the gap or the opposite side of the bipolar electrode stack from the gap such that at least part of the gap or the opposite side of the bipolar electrode stack from the gap does not contact the conveyor roller.

### CROSS-REFERENCE TO RELATED APPLICATION

This application claims priority to Japanese Patent Application No. 2024-175070 filed on Oct. 4, 2024. The disclosure of the above-identified application, including the specification, drawings, and claims, is incorporated by reference herein in its entirety.

### BACKGROUND

### 1. Technical Field

The present disclosure relates to methods for manufacturing a battery.

### 2. Description of Related Art

As disclosed in Japanese Unexamined Patent Application Publication No. 2017-228349 (JP 2017-228349 A) and Japanese Unexamined Patent Application Publication No. 2009-298496 (JP 2009-298496 A), there is known a technique for reducing wrinkling of an electrode stack conveyed by rollers.

Japanese Unexamined Patent Application Publication No. 2023-073069 (JP 2023-073069 A), Japanese Unexamined Patent Application Publication No. 2022-066723 (JP 2022-066723 A), Japanese Unexamined Patent Application Publication No. 2009-049006 (JP 2009-049006 A), and Japanese Unexamined Patent Application Publication No. 2022-139880 (JP 2022-139880 A) disclose an electrode stack having a gap in the surface of an electrode active material layer.

### SUMMARY

The disclosers found that, in manufacturing of a bipolar electrode stack having a gap in the surface of one electrode active material layer, the other electrode active material layer on the opposite side from the gap tends to crack while the bipolar electrode stack is being conveyed by rollers.

An object of the present disclosure is to provide a method for manufacturing a battery that can reduce such cracking of an electrode active material layer.

The disclosers found that the above issue can be resolved by the following measures.

A method for manufacturing a battery includes
conveying a heated bipolar electrode stack in the form of an elongated sheet by a conveyor roller.
   The bipolar electrode stack includes a first electrode active material layer, a current collector layer, and a second electrode active material layer in this order.
   The first electrode active material layer includes a plurality of island portions extending in a conveying direction, and at least one gap extending in the conveying direction is present between the island portions.
   A temperature drop of the bipolar electrode stack as the bipolar electrode stack passes over the conveyor roller is 30° C. or more.
   The conveyor roller includes a recess positioned to overlap with the gap or the opposite side of the bipolar electrode stack from the gap such that at least part of the gap or the opposite side of the bipolar electrode stack from the gap does not contact the conveyor roller.
   In the method described above,
the width of the recess may be equal to or larger than the width of the gap.
   In the method described above,
in the conveyor roller, an end of a portion that contacts the bipolar electrode stack other than the recess may be chamfered.
   The above method may further include
drying the first electrode active material layer and the second electrode active material layer by laser heating prior to the conveying by the conveyor roller.
   The above method may further include
pressing the bipolar electrode stack prior to the drying.

The method for manufacturing a battery according to the present disclosure can reduce such cracking of an electrode active material layer as described above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a method of the present disclosure;

FIG. 2 is a schematic cross-sectional view illustrating an example of a bipolar electrode stack according to the method of the present disclosure;

FIG. 3 is a schematic top view of an exemplary disclosed process; and

FIG. 4 is a schematic cross-sectional view illustrating an example of a method of the present disclosure.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Method for Manufacturing Battery

A method for manufacturing a battery according to the present disclosure includes conveying a heated bipolar electrode stack in the form of an elongated sheet by a conveyor roller. In the method of the present disclosure, the bipolar electrode stack includes a first electrode active material layer, a current collector layer, and a second electrode active material layer in this order. The first electrode active material layer includes a plurality of island portions extending in the conveying direction, and at least one gap extending in the conveying direction is present between the island portions. A temperature drop of the bipolar electrode stack as the bipolar electrode stack passes over the conveyor roller is 30° C. or more. The conveyor roller includes a recess positioned to overlap with the gap or the opposite side of the bipolar electrode stack from the gap. At least part of the gap or the opposite side of the bipolar electrode stack from the gap therefore does not contact the conveyor roller.

As described above, the disclosers found that, in manufacturing of a bipolar electrode stack having a gap in the surface of one electrode active material layer (first electrode active material layer), the other electrode active material layer (second electrode active material layer) on the opposite side from the gap tends to crack while the bipolar electrode stack is being conveyed by a conveyor roller.

The disclosers considered that one of the causes of such cracking of the second electrode active material layer on the opposite side from the gap is thermal shrinkage. That is, when the heated bipolar electrode stack in the form of an elongated sheet is conveyed by the conveyor roller, the temperature of the bipolar electrode stack is considered to be lowered by the conveyor roller. It is considered that the gap of the bipolar electrode stack has a smaller rigidity than the other portions, and therefore wrinkles due to heat shrinkage occur in the gap. It is considered that wrinkles generated in this manner interfere with the conveyor roller, causing cracking of the second electrode active material layer on the opposite side from the gap.

On the other hand, the inventors of the present disclosure found that, even when the temperature of the bipolar electrode stack is lowered by the conveyor roller, the conveyor roller has a recess positioned to overlap with the gap or the opposite side of the bipolar electrode stack from the gap such that at least part of the gap or the opposite side of the bipolar electrode stack from the gap does not contact the conveyor roller, which can reduce cracking of the second electrode active material layer on the opposite side from the gap. The reason for this is considered to be that, since the conveyor roller has a recess positioned to overlap with the gap or the opposite side of the bipolar electrode stack from the gap, wrinkles hardly interfere with the conveyor roller even if such wrinkles are generated in the gap due to thermal shrinkage caused by the temperature drop of the bipolar electrode stack.

Hereinafter, a method of manufacturing an electrode according to the present disclosure will be described with reference to the drawings. The dimensional relationship in the drawings does not reflect the actual dimensional relationship.

### Roller Conveyance

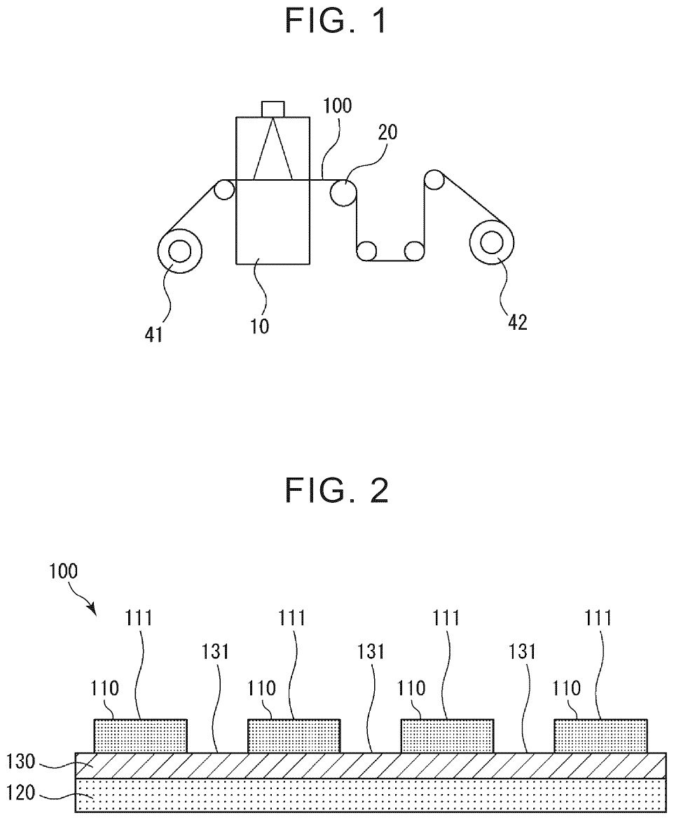

As illustrated in FIG. 1, the method of the present disclosure includes conveying a heated bipolar electrode stack 100 in the form of an elongated sheet by a conveyor roller 20. Note that FIG. 1 is a schematic diagram illustrating an embodiment in which the bipolar electrode stack is wound on the winding reel 42 from the unwinding reel 41 via heating (drying) by the laser irradiation device 10 and roller conveyance by the conveyor roller 20.

The heating temperature is not particularly limited, but may be, for example, 120° C. or higher, 130° C. or higher, 140° C. or higher, 150° C. or higher, 160° C. or higher, 170° C. or higher, 180° C. or higher, 190° C. or higher, or 200° C. or higher, and may be 300° C. or lower, 290° C. or lower, 280° C. or lower, 270° C. or lower, 260° C. or lower, or 250° C. or lower. When the heating temperature is within the above range, it is considered that the temperature of the bipolar electrode stack 100 is easily lowered by the conveyor roller 20 when the bipolar electrode stack 100 is conveyed by the conveyor roller 20. Based on such an estimation, it is particularly effective to apply the method of the present disclosure to a bipolar electrode stack heated at a temperature within the above range.

As illustrated in FIG. 2, in the method of the present disclosure, the bipolar electrode stack includes a first electrode active material layer 110, a current collector layer 130, and a second electrode active material layer 120 in this order.

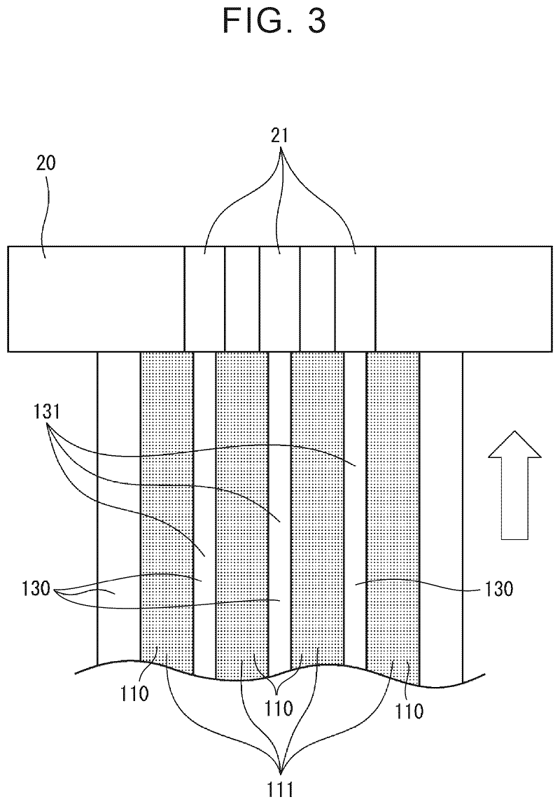

As illustrated in FIGS. 2 and 3, in the method of the present disclosure, the first electrode active material layer 110 includes a plurality of island portions 111 extending in a conveying direction, and at least one gap 131 extending in the conveying direction is present between the island portions. The conveying direction is shown by an arrow in FIG. 3.

The number of island portions 111 and the number of gaps 131 are not particularly limited. For example, when the number of gaps 131 is n, the number of island portions may be n+1. In this case, n is not particularly limited, but may be 1 or more, 2 or more, 3 or more, 5 or more, 7 or more, 9 or more, or 10 or more, and may be 30 or less, 25 or less, 20 or less, or 15 or less.

The gap 131 may extend either along the entire bipolar electrode stack 100 or along a part of the bipolar electrode stack 100 in the conveying direction of the bipolar electrode stack 100.

The first electrode active material layer 110 including the island portions 111 may be a cathode active material layer or an anode active material layer, and in particular, may be a cathode active material layer. The second electrode active material layer 120 may be a cathode active material layer or an anode active material layer, and particularly may be an anode active material layer.

In the method of the present disclosure, the temperature drop of the bipolar electrode stack 100 as the bipolar electrode stack passes over the conveyor roller 20 is 30° C. or higher.

The temperature drop of the bipolar electrode stack 100 may be caused as the temperature of the conveyor roller 20 is lower than the temperature of the heated bipolar electrode stack 100.

The temperature drop of the bipolar electrode stack 100 may be 40° C. or higher, 50° C. or higher, 60° C. or higher, 70° C. or higher, 80° C. or higher, 90° C. or higher, or 100° C. or higher, and may be 150° C. or lower, 130° C. or lower, or 110° C. or lower. When the temperature drop of the bipolar electrode stack 100 is within the above range, thermal shrinkage in the gap 131 of the bipolar electrode stack 100 tends to occur. It is therefore of great significance to apply the method of the present disclosure.

The temperature of the bipolar electrode stack may be monitored by a thermometer, such as a temperature sensor. The thermometer may in particular be a non-contact radiation thermometer.

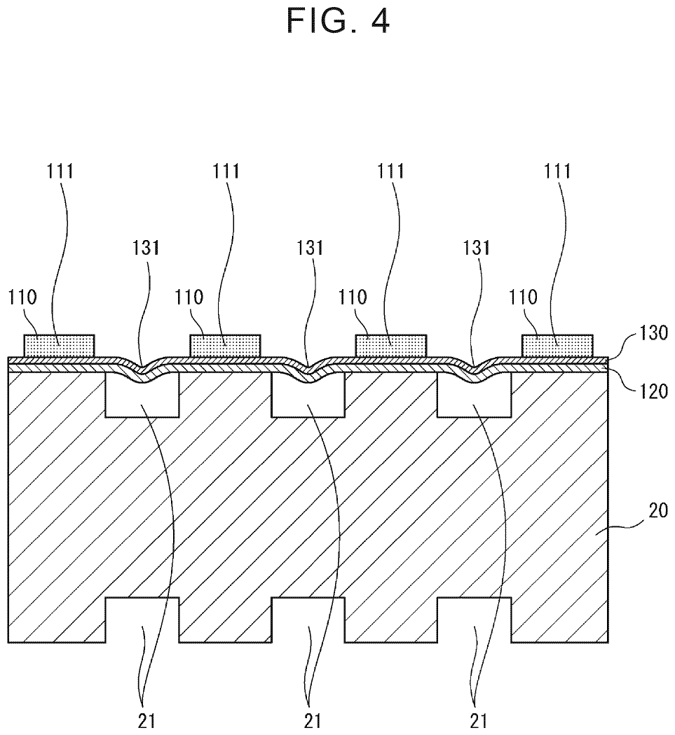

As illustrated in FIGS. 3 and 4, in the method of the present disclosure, the conveyor roller 20 has a recess 21 positioned to overlap with the gap 131 or the opposite side of the bipolar electrode stack from the gap 131. Thereby, at least part of the gap 131 or the opposite side of the bipolar electrode stack 100 from the gap 131, in particular, the entire gap 131 or the entire opposite side of the bipolar electrode stack 100 from the gap 131, does not contact the conveyor roller 20. With such a configuration, it is possible to reduce cracking of the second electrode active material layer 120 on the opposite side from the gap 131. In the embodiments illustrated in FIGS. 3 and 4, the bipolar electrode stack 100 is conveyed such that the second electrode active material layer 120 side of the bipolar electrode stack 100 is in contact with the conveyor roller 20. In FIG. 3, the bipolar electrode stack 100 overlapping with the conveyor roller 20 is omitted for the sake of explanation.

The position of the recess 21 in the conveyor roller 20 is not particularly limited as long as at least part of the recess 21 overlaps with the gap 131 or the opposite side from the gap 131. For example, as illustrated in FIG. 4, the position of the center of the recess 21 and the position of the center of the gap 131 may substantially coincide with each other in the transverse direction of the gap 131.

As illustrated in FIG. 3, in the method of the present disclosure, the width of the recess 21 may be equal to or larger than the width of the gap 131. With such a configuration, wrinkles generated in the gap 131 are less likely to interfere with the second electrode active material layer. In the context of the present disclosure, “width” means the transverse length of the gap 131.

The width of the recess 21 can be appropriately designed in consideration of the degree of wrinkles that may occur in the gap 131 etc.

The width of the gap can be appropriately set in consideration of a desired battery capacity or the like.

The recess 21 may be formed on a part of the outer periphery of the conveyor roller 20, or may be formed over the entire outer periphery.

In the method of the present disclosure, in the conveyor roller, the shape of the end of the portion in contact with the bipolar electrode stack other than the recess is not particularly limited, but in particular, the end may be chamfered. The chamfered end can reduce the possibility of damage to the bipolar electrode stack 100. The chamfering may particularly be round (R) chamfering. In this case, the R-chamfer radius may be 0.1 mm or more, 0.3 mm or more, or 0.5 mm or more, and may be 10.0 mm or less, 5.0 mm or less, 3.0 mm or less, 2.0 mm or less, or 1.0 mm or less.

Note that FIG. 3 illustrates an embodiment in which the second electrode active material layer 120 is disposed inside the conveyor roller 20 in the radial direction, that is, on the side in contact with the conveyor roller 20. However, in the method of the present disclosure, the first electrode active material layer 110 may be disposed on the side in contact with the conveyor roller 20.

In the method of the present disclosure, the temperature of the bipolar electrode stack during roller conveyance is not particularly limited, but may be 40° C. or higher, 50° C. or higher, 60° C. or higher, 70° C. or higher, 80° C. or higher, 90° C. or higher, or 100° C. or higher, and may be 150° C. or lower, 140° C. or lower, 130° C. or lower, 120° C. or lower, 110° C. or lower, or 100° C. or lower. When the temperature is within the above range, the temperature of the bipolar electrode stack tends to drop. It is therefore of great significance to apply the method of the present disclosure.

When the bipolar electrode stack 100 is conveyed by the conveyor roller 20, the conveying direction of the bipolar electrode stack 100 may be changed by a predetermined angle or more. This increases the length along which the bipolar electrode stack 100 and the conveyor roller 20 can contact each other, which can effectively reduce cracking of the second electrode active material layer due to the recess 21. The predetermined angle is not particularly limited, but may be, for example, 45° or more, 60° or more, 70° or more, 80° or more, 85° or more, or 90° or more, and may be 180° or less, 150° or less, 130° or less, 120° or less, 110° or less, 100° or less, 95° or less, or 90° or less.

In the method of the present disclosure, the conveyor roller may be used in multiple stages in the conveying direction of the electrode active material layer. The number of stages of the conveyor roller is not particularly limited, and can be appropriately set from the viewpoint of suppression of cracking of the electrode active material layer, space saving, and the like.

### Drying

The method of the present disclosure may further include drying the first electrode active material layer 110 and the second electrode active material layer 120 by laser heating prior to roller conveyance. According to the laser heating, the bipolar electrode stack can be heated efficiently. During laser heating, air blowing may be used in combination. Air blowing may be hot air blowing.

As illustrated in FIG. 1, laser heating may be performed by the laser irradiation device 10. Note that the laser heating and the roller conveyance may be performed continuously as illustrated in FIG. 1 or may be performed discontinuously.

When the first electrode active material layer and the second electrode active material layer are dried by laser heating, the target of laser irradiation may be any of the first and second electrode active material layers. When the first electrode active material layer is a cathode active material layer, in particular, the first electrode active material layer may be heated by irradiating a laser beam.

### Pressing

Although not shown, the method of the present disclosure may further include pressing the bipolar electrode stack 100 prior to drying.

When the second electrode active material layer 120 contains a binder, it is considered that the binder is compacted in the second electrode active material layer 120 that has undergone the pressing, and thus the flexibility is reduced. Based on such estimation, it is particularly effective to apply the method of the present disclosure to the bipolar electrode stack 100 that has undergone the pressing.

The method of the pressing is not particularly limited, and a common method can be adopted.

The pressure of the press is not particularly limited, and can be set as appropriate such that the density of the electrode active material layer becomes a desired value.

### Low Temperature Drying

The method of the present disclosure may further include drying the first and second electrode active material layers at a temperature lower than the temperature in drying by laser heating described above prior to pressing. The drying temperature in this step may be 80° C. or higher, 90° C. or higher, or 100° C. or higher, and may be 140° C. or lower, 130° C. or lower, or 120° C. or lower.

### Battery

The battery of the present disclosure is manufactured by the method of the present disclosure for manufacturing a battery. In the battery of the present disclosure, cracking of the second electrode active material layer on the opposite side of the bipolar electrode stack 100 from the gap 131 is reduced.

The battery of the present disclosure includes a bipolar electrode stack 100 and may optionally have an electrolyte layer.

The battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

The battery of the present disclosure may be a primary battery or a secondary battery. In particular, it may be a lithium-ion secondary battery.

Hereinafter, components of the battery will be described.

### Current Collector Layer

A known current collector layer can be used as a current collector layer of a battery. The current collector layer may be, for example, a copper foil, a copper alloy foil, a nickel foil, an aluminum foil, an aluminum alloy foil, a stainless steel foil, a carbon sheet, or the like.

The current collector layer may have two different current collector layers. In this case, the current collector layers may be bonded to each other via a conductive adhesive layer, or may be bonded by pressing or the like. For example, the current collector layer on the anode active material layer side may be a copper foil, and the current collector layer on the cathode active material layer side may be an aluminum foil.

The thickness of the current collector layer is not particularly limited, but may be 1 μm or more and 300 μm or less, 5 μm or more and 200 μm or less, or 10 μm or more and 100 μm or less. When the current collector layer has two current collector layers bonded together via an electrically conductive adhesive layer, the total thickness of the layers may be in the above range.

The size of the current collector layer is not particularly limited, and can be appropriately set in consideration of, for example, a desired capacity of the battery.

The shape of the current collector layer in the battery obtained by the method of the present disclosure is not particularly limited, but may be, for example, a quadrilateral such as a rectangle.

### First and Second Electrode Active Material Layers

The first and second electrode active material layers include an electrode active material, and may optionally include a binder, a conductive aid, and other components.

The electrode active material layer can be formed from an electrode mixture slurry.

In the context of the present disclosure, the term “mixture” means a composition capable of forming an electrode active material layer or the like as it is or by further containing other components. In addition, in the context of the present disclosure, a “mixture slurry” means a slurry that includes a dispersion medium in addition to a “mixture” and that can be applied and dried to form an electrode active material layer or the like.

The thickness of the electrode active material layer is not particularly limited. The thickness of the electrode active material layer may be 10 μm or more and 500 μm or less, 100 μm or more and 450 μm or less, or 200 μm or more and 400 μm or less.

The size of the electrode active material layer is not particularly limited, and can be appropriately set in consideration of, for example, a desired capacity of the battery.

The shape of the first and second electrode active material layers in the battery obtained by the method of the present disclosure is not particularly limited, but may be, for example, a rectangle such as a rectangle.

### Electrode Active Material

The electrode active material is not particularly limited. For the present disclosure, for example, when the first electrode active material layer is a cathode active material layer, the first electrode active material layer may include a cathode active material. For example, when the second electrode active material layer is an anode active material layer, the second electrode active material layer may include an anode active material.

The cathode active material is not particularly limited as long as it has a noble potential as compared with the anode active material. When the bipolar electrode stack of the present disclosure is a bipolar electrode stack for a lithium-ion secondary battery, examples of the cathode active material include: composite oxides such as lithium cobaltate (LiCoO₂), lithium nickelate (LiNiO₂), lithium manganate (LiMn₂O₄), solid solution oxides (LizMnO₃-LiMO₂ (M=Co, Ni, etc.)), lithium nickel manganese oxide (LiNi_{1/2}nMn_{1/2}O₂), lithium nickel manganese cobalt oxide (LiNi_{1/3}Mn_{1/3}Co_{1/3}O₂), and olivine lithium phosphate (LiFePO₄); electrically conductive polymers such as polyaniline and polypyrrole; sulfide-based cathode active materials such as Li₂S, CuS, Li—Cu—S compounds, TiS₂, FeS, MoS₂, Li—Mo—S compounds, Li—Ti—S compounds, and Li-V-S compounds; and materials using sulfur as an active material such as acetylene black impregnated with sulfur, porous carbon impregnated with sulfur, and mixed powder of sulfur and carbon. These cathode active materials may be used singly or in combinations of two or more.

The content of the cathode active material in the cathode mixture as an electrode mixture may be more than 50% mass, more than 70% mass, more than 90% mass, or more than 95% mass.

The shape of the cathode active material may be, for example, particulate.

The anode active material is not particularly limited as long as it has a lower potential than that of the cathode active material. When the bipolar electrode stack of the present disclosure is a bipolar electrode stack for a lithium-ion secondary battery, examples of the anode active material include: carbonaceous materials such as graphite (artificial graphite, natural graphite), resin carbon, carbon fibers, activated carbon, hard carbon, and soft carbon; metal-based materials such as tin, tin alloys, silicon, silicon alloys, gallium, gallium alloys, indium, indium alloys, aluminum, and aluminum alloys; electrically conductive polymers such as polyacene, polyacetylene, and polypyrrole; metallic lithium; lithium-titanium composite oxides such as Li₄Ti₅O₁₂; and lithium alloys such as Li—Si alloys, Li—Sn alloys, Li—Al alloys, Li—Ga alloys, Li—Mg alloys, and Li—In alloys. These anode active substances may be used singly or in combinations of two or more.

The content of the anode active material in the anode mixture as an electrode mixture may be more than 50% by mass, 70% by mass, more than 90% by mass, or more than 95% by mass.

The shape of the anode active material may be, for example, particulate.

### Binder

The binder is not particularly limited. When the battery of the present disclosure is a lithium-ion secondary battery, examples of the binder include polyvinylidene fluoride (PVdF), polytetrafluoroethylene, polyethylene, polypropylene, aramid resins, polyamides, polyimides, polyamide-imides, polyvinyl alcohol, polyacrylonitrile, polyacrylic acid, polymethylacrylate, polyethylacrylate, polyhexylacrylate, polymethacrylic acid, polymethylmethacrylate, polyethylmethacrylate, polyhexylmethacrylate, polyvinyl acetate, polyvinylpyrrolidone, polyethers, polyethersulfone, polyhexafluoropropylene, styrene-butadiene rubber, and carboxymethyl cellulose. These binders may be used singly or in combinations of two or more.

The content of the binder in the electrode mixture is not particularly limited, and can be appropriately set according to a desired binding property or the like.

### Conductive Aid

The conductive aid is not particularly limited. When the battery of the present disclosure is a lithium-ion secondary battery, examples of the conductive aid include: graphite such as natural graphite and artificial graphite; carbon blacks such as acetylene black, Ketjen black, channel black, furnace black, lamp black, and thermal black; electrically conductive fibers such as carbon fibers like carbon nanotubes and metal fibers; metal powders such as aluminum powder; electrically conductive whiskers such as zinc oxide whiskers and electrically conductive potassium titanate whiskers; electrically conductive metal oxides such as titanium oxide; and organic electrically conductive materials such as phenylene derivatives. These conductive aids may be used singly or in combinations of two or more.

The content of the conductive aid in the electrode mixture is not particularly limited, and can be appropriately set according to desired electrical conductive properties etc.

### Other Components

The electrode mixture may contain components other than those described above. Examples of such a component include a solid electrolyte and a dispersant.

### EXAMPLES 1, 2 AND COMPARATIVE EXAMPLE 1

### Example 1

The bipolar electrode stack in the form of an elongated sheet was heated by laser irradiation. As shown in FIG. 2, the cathode active material layer as the first electrode active material layer of the bipolar electrode stack used includes a plurality of island portions extending in the conveying direction, and a plurality of gaps extending in the conveying direction is present between the island portions. As shown in FIG. 2, an anode active material layer as the second electrode active material layer of the bipolar electrode stack used is present on the entire surface on the opposite side from the cathode active material layer.

As shown in FIGS. 3 and 4, the heated bipolar electrode stack is conveyed by a conveyor roller having a recess positioned to overlap with the opposite side of the bipolar electrode stack from the gap. The roller conveyance was performed by disposing an anode active material layer as the second electrode active material layer on the side of the conveyor roller. The temperature drop of the bipolar electrode stack as the bipolar electrode stack passes over the conveyor roller was 30° C.

### Example 2

The bipolar electrode stack was conveyed by a roller in the same manner as in Example 1 except that a conveyor roller in which an end of a portion that contacts the bipolar electrode stack other than the recess was subjected to R-chamfering (chamfer radius: 0.5 mm) was used.

### Comparative Example 1

The bipolar electrode stack was roller-conveyed in the same manner as in Example 1 except that a conveyor roller having no recess was used.

### EVALUATION

The presence or absence of cracks and scratches in the anode active material layer as the second electrode active material layer on the opposite side of the bipolar electrode stack from the gap was visually checked. The results are shown in Table 1.

TABLE 1

| | | Condition of Second Electrode | |
|---|---|---|---|
| | Conveyor | Active Material Layer | |
| | Roller | Cracks | Scratches |
| Example 1 | With Recesses | No | Yes |
| Example 2 | With Recesses | No | No |
| | (Chamfered) | | |
| Comparative | — | Yes | — |
| Example 1 | | | |

What is claimed is:

1. A method for manufacturing a battery, the method comprising conveying a heated bipolar electrode stack in a form of an elongated sheet by a conveyor roller, wherein:
the bipolar electrode stack includes a first electrode active material layer, a current collector layer, and a second electrode active material layer in an order of the first electrode active material layer, the current collector layer, and the second electrode active material layer;
the first electrode active material layer includes a plurality of island portions extending in a conveying direction, and at least one gap extending in the conveying direction is present between the island portions;
a temperature drop of the bipolar electrode stack as the bipolar electrode stack passes over the conveyor roller is 30° C. or more; and
the conveyor roller includes a recess positioned to overlap with the gap or an opposite side of the bipolar electrode stack from the gap such that at least part of the gap or the opposite side of the bipolar electrode stack from the gap does not contact the conveyor roller.

2. The method according to claim 1, wherein a width of the recess is equal to or larger than a width of the gap.

3. The method according to claim 1, wherein, in the conveyor roller, an end of a portion that contacts the bipolar electrode stack other than the recess is chamfered.

4. The method according to claim 1, further comprising drying the first electrode active material layer and the second electrode active material layer by laser heating prior to the conveying by the conveyor roller.

5. The method according to claim 4, further comprising pressing the bipolar electrode stack prior to the drying.
